(19) United States
(12) Patent Application Publication
(10) Pub. No.: US 2017/0252843 A1
(43) Pub. Date: Sep. 7, 2017

(54) AXIAL HOB WITH MULTI-REVOLUTION CUTTING TEETH

(71) Applicant: THE GLEASON WORKS, Rochester, NY (US)

(72) Inventors: Takahiro Matsubara, Tokyo (JP); Hermann J. Stadtfeld, Webster, NY (US)

(21) Appl. No.: 15/509,509

(22) PCT Filed: Sep. 30, 2015
(86) PCT No.: PCT/US2015/053111

§ 371 Date: Mar. 8, 2017

Related U.S. Application Data
(60) Provisional application No. 62/058,719, filed on Oct. 2, 2014.

(51) Int. Cl. B23F 21/12; B23F 21/24; B23F 21/26; B23F 21/16

(52) U.S. Cl. CPC B23F 21/12; B23F 21/16; B23F 21/24; B23F 21/26

(57) ABSTRACT

An axial hob (14) with cutting teeth (16) which are arranged around a cylinder (19) in a helical pattern. The cutting front (18) is perpendicular to the helix. The re-grindable blade thickness is oriented in the direction of the helix lead direction. While the tool rotates, the active cutting front changes from one blade to the next which, depending on the hand of rotation, is an advanced or retracted position. However, the rotation will not give the individual blades a chip removing motion but only position the following blade in an advanced or retracted location, such as in a gear slot to be machined.

This applications claims the benefit of U.S. Provisional Patent Application No. 62/058,719 filed Oct. 2, 2014, the entire disclosure of which is hereby incorporated by reference.

### FIELD OF THE INVENTION

The invention relates to a cutting tool having teeth that are arranged around a cylinder in a helical pattern. The cutting front is perpendicular to the helix.

### BACKGROUND OF THE INVENTION

Cylindrical hobs are used for the manufacture of external cylindrical gears, such as spur gears, helical gears and worm gears. The manufacture of internal gears is not possible using a cylindrical hobbing tool due to mutilation left and right to the center line. The profile of a cylindrical hob is a trapezoid which reflects the pressure angle and module (depth and spacing) of the part to be manufactured and is known as a “reference profile”. The reference profile can be observed in a plane through the center of the hob in an axial plane (e.g. a horizontal plane in FIG. 1). The axes directions of the hob and the work in the case of spur gear manufacturing are perpendicular or slightly inclined about an angle, which is the same or similar magnitude than the lead angle of the hob teeth.

In case of helical gears, the hob axis is inclined to the work axis by the value of the helix angle with the possible addition or subtraction of the hob lead angle (depending on the lead direction). One hob revolution (in case of a single start hob) requires a shift of the virtual generating rack in direction “G” by one pitch. If, for example, an external cylindrical work gear is positioned on the opposite side of the rack than the hob, and if this work gear is “engaged” with the virtual generating rack, then the hob will cut involute teeth onto the work gear blank while it rotates (direction F). The work gear has to rotate one pitch during each hob revolution (one start hob). Because the generating rack has to shift in direction “G” while the hob rotates, the work gear will also have to rotate in direction “C” in order generate the involute profile and also in order to work its way around the work gear and cut all the teeth (slots) on the work gear circumference.

Shaping is a method where a cylindrical pinion shaped cutter strokes axially (V in FIG. 2) while it is engaged with an external or internal work piece. Every forward stroke removes material while simultaneously to the stroking a continuous index rotation between shaper cutter and work piece is performed. While the shaper cutter rotates one pitch (rotation Sₖ), the generating rack shifts one pitch in direction “G” and the work gear rotates one pitch in rotational direction “C” (in FIG. 2). Every reverse stroke is unproductive, which makes shaping a rather slow process. Shaping has its strength in the machining of internal gears (which is not possible with hobbing) or gears which allow no over-travel clearance behind the end of the teeth to be machined (also often not possible with hobbing).

Power skiving is a method which utilizes the relative motion between the work and a disk shaped cutter with peripheral cutting teeth. The relative motion is created with the inclination angle between work and cutter (see shaft angle Σ in FIG. 3). The cutting teeth are engaged in the slots of the work piece while cutter and work piece rotate and create the velocities Vₜₒₒₗ and V_{work} in FIG. 3. The difference between the two peripheral velocities is utilized as cutting velocity V_{cut}.

### SUMMARY OF THE INVENTION

The invention relates to an axial hob with cutting teeth which are arranged around a cylinder in a helical pattern. The cutting front is perpendicular to the helix. The re-grindable blade thickness is oriented in the direction of the helix lead direction (e.g. FIG. 4). While the tool rotates, the active cutting front changes from one blade to the next which, depending on the hand of rotation, is an advanced or retracted position. However, the rotation will not give the individual blades a chip removing motion but only position the following blade in an advanced or retracted location, e.g. in a gear slot to be machined.

### BRIEF DESCRIPTION OF THE DRAWINGS

FIG. 1 shows a three dimensional graphic of a cylindrical hob, a virtual generating rack and a work gear.

FIG. 2 shows a three dimensional graphic of a shaper cutter, a virtual generating rack and a work gear.

FIG. 3 shows the orientation of a power skiving cutter and internal gear, front and top view.

FIG. 4 shows the three dimensional view of an axial hob with multi-revolution cutting teeth.

FIG. 5(a) shows an end view and FIG. 5(b) shows a side (lengthwise) view of a helical axial hob.

FIG. 6 shows the three dimensional view of an axial zero lead angle hob.

FIG. 7 shows the three dimensional representation of a mounted multi-disk hob.

FIG. 8 shows the three dimensional representation of a mounted stick blade hob.

FIG. 9(a) shows the orientation between tool and work for the power skiving of an external gear with an axial hob. The only feed direction is a radial infeed.

FIG. 9(b) shows the orientation between tool and work for the power skiving of an external gear with an axial hob. The feed is in axial hob direction.

FIG. 10 shows the orientation between tool and work for the power skiving of an external gear with an axial hob. The feed direction of the hob is in axial work gear direction.

FIG. 11 shows the orientation between tool and work for the power skiving of an internal gear with an axial hob. The feed direction of the hob is radial in direction.

FIG. 12 shows the orientation between tool and work for the power skiving of an internal gear with an axial hob. The feed direction of the hob is in the axial hob direction.

FIG. 13 shows the orientation between tool and work for the power skiving of an internal gear with an axial hob. The feed direction of the hob is in the axial work gear direction.

### DETAILED DESCRIPTION OF THE PREFERRED EMBODIMENT

The terms “invention,” “the invention,” and “the present invention” used in this specification are intended to refer broadly to all of the subject matter of this specification and any patent claims below. Statements containing these terms should not be understood to limit the subject matter described herein or to limit the meaning or scope of any patent claims below. Furthermore, this specification does not seek to describe or limit the subject matter covered by any claims in any particular part, paragraph, statement or drawing of the application. The subject matter should be understood by reference to the entire specification, all drawings and any claim below. The invention is capable of other constructions and of being practiced or being carried out in various ways. Also, it is understood that the phraseology and terminology used herein is for the purposes of description and should not be regarded as limiting. The use of “including”, “having” and “comprising” and variations thereof herein is meant to encompass the items listed thereafter and equivalents thereof as well as additional items.

The details of the invention will now be discussed with reference to the accompanying drawings which illustrate the invention by way of example only. In the drawings, similar features or components will be referred to by like reference numbers.

Although references may be made below to directions such as upper, lower, upward, downward, rearward, bottom, top, front, rear, etc., in describing the drawings, there references are made relative to the drawings (as normally viewed) for convenience. These directions are not intended to be taken literally or limit the present invention in any form unless specified.

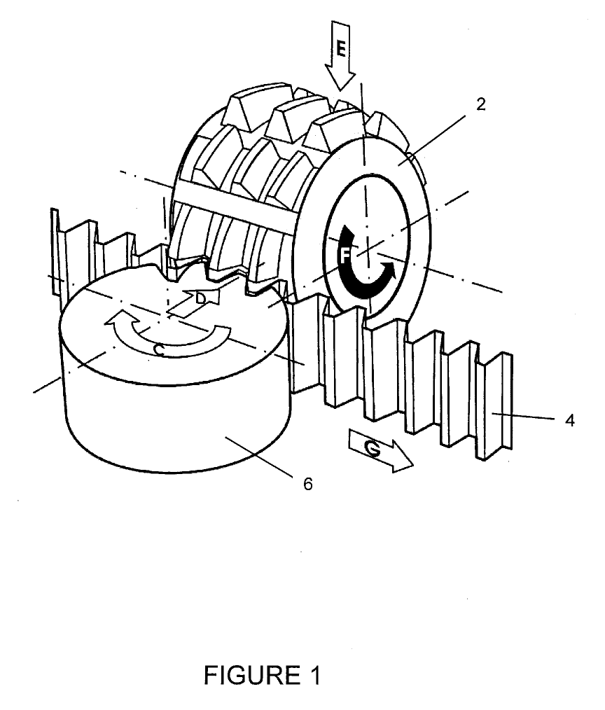

FIG. 1 shows a three dimensional graphic of a cylindrical hob 2 and virtual generating rack 4. The hob simulates the profile of the generating rack in a horizontal plane (the drawing shows the top profile plane of the rack), which in the simple case shown in FIG. 1 contains the axis of rotation of the hob. If the hob rotates (as indicated by “F”), the generating rack will move in direction “G”. In case of a hob with one start, one revolution will shift the rack one pitch in direction G. In order to cut a gear with the face width of the rack in FIG. 1, the hob has to move in direction “E”, until the horizontal plane (which includes the hob axis) reaches the bottom profile plane of the rack. Thus, the hob teeth show the rack profile on their front face, if the front face coincides with an axial plane. Each hob revolution, which shifts the rack by one pitch, also requires the rotation of the work piece 6 by one pitch (rotation C). In such a case all major cutting forces are tangential to the hob and directly translate into the torque which is required to rotate the hob.

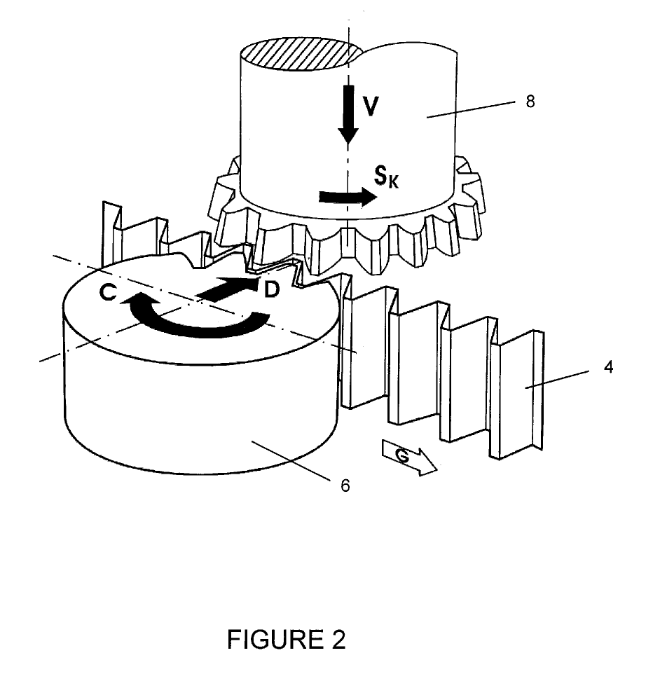

FIG. 2 shows a three dimensional graphic of a shaper cutter 8 and a virtual generating rack. While the shaper cutter rotates (as indicated by Sₖ) around its axis, the generating rack shifts in direction “G” and the involute profile of the shaper cutter teeth will form the trapezoidal reference profile of the rack. Although the described cutter rotation and rack shift will form the profile of the rack, it will not provide any cutting action. The shaper cutter teeth have the involute profile which is required to form the straight profile of the rack teeth in a radial plane (perpendicular to the axis of the shaper cutter). The stroke motion “V” in axial direction of the shaper cutter is required to introduce a cutting action and is also necessary to cut the face width of a gear. If the length of the stroke is equal to the width of the rack, then it is possible to cut a cylindrical gear with the same face width as shown in FIG. 2. While the generating rack shifts in direction “G” e.g. by one pitch, the work which is engaged with the rack has to also rotate by one pitch (rotation C). In the case shown in FIG. 2, all major cutting forces are directed in axial shaper cutter direction.

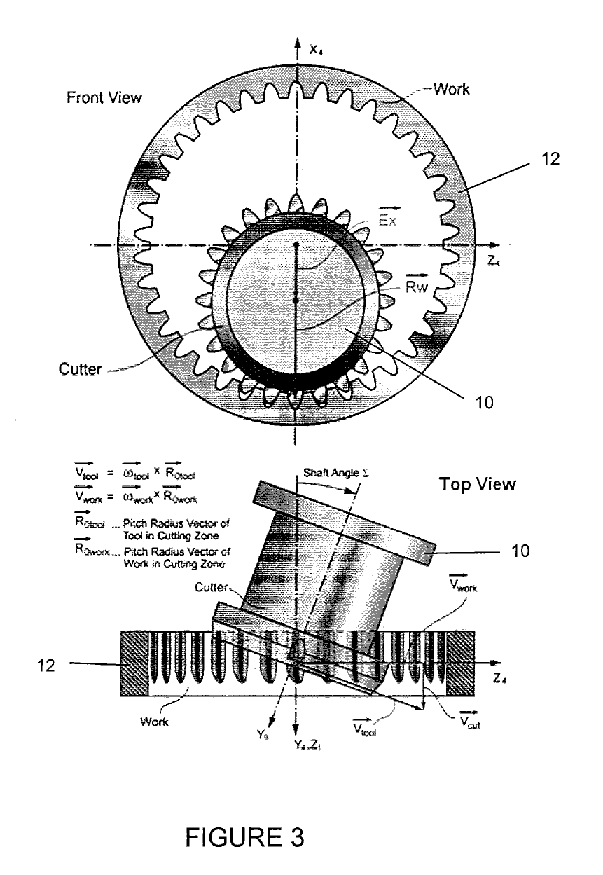

FIG. 3 shows the orientation of a power skiving cutter 10 and an internal gear 12, front and top view. While the cutter rotates, the involute profiles of its teeth form the straight profiles of a virtual generating rack (not shown in FIG. 3). The rotation of the cutter shifts the generating rack sideways (like in FIG. 2). Covering the width of the generating rack teeth (equivalent with the face width of a cylindrical gear to be cut) requires a feed motion of the cutter in axial work gear direction (Y₄, Z₄).

In contrast to the shaper cutter 8 in FIG. 2, the cutting action is not generated by axial stroking but instead by the relative motion between the skiving cutter 10 and the work gear 12 (during the synchronized rotation of both) which is directed in lead direction of the work gear teeth. Thus, the cutting velocity V_{cut} is a function of the cutter RPM (or angular velocity ωₜₒₒₗ) and the inclination angle Σ:

V_{cut}=ωₜₒₒₗ*sinΣ

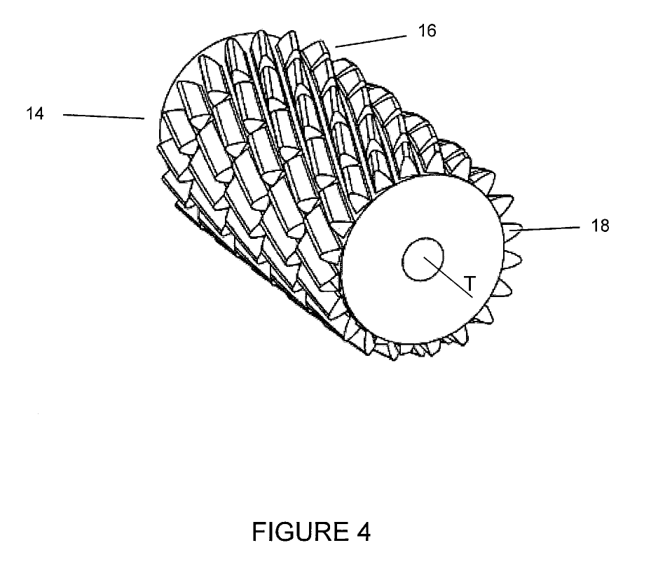

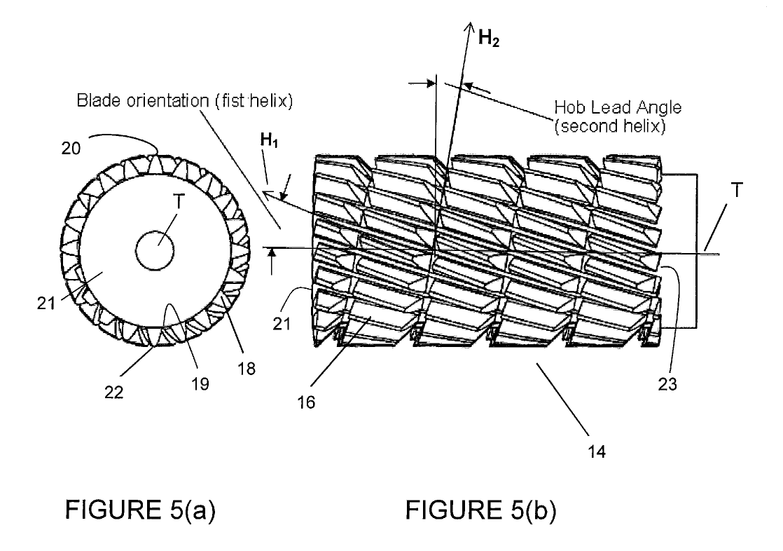

FIG. 4 shows a three dimensional view of an axial hob 14 with multi-revolution cutting teeth 16 rotatable about a hob axis T. The teeth (i.e. cutting blades) 16 of the hob shaped cutter 14 are oriented in a first helix direction H₁ (i.e. at a first helix angle) where the blades are grouped along a second helix direction H₂ (i.e. at a second helix angle) on the periphery of a cylinder 19 (see FIGS. 5a) and (5b)) which has the effect of winding the blades along the length of the cylindrical hob. The hob 14 extends a certain axial length between a pair of axially opposed ends, first end 21 and second end 23. The actual length of the axial hob is determined based on factors such as the particular hobbing machine, workpiece dimensions, process parameters, etc., as would be understood by the skilled artisan. The first helix angle is measured with respect to the hob axis T and the second helix angle is measured with respect to a line perpendicular to the hob axis T as seen in FIG. 5(b). The first helix is analogous to the helix angle of a cylindrical gear. The second helix has a fixed lead angle (i.e. second helix angle) which threads the blades along the width of the cylinder 19. The direction of the second helix is preferably perpendicular to the direction of the first helix which will create blade front faces 18 (i.e. cutting faces) with equal side rake angles (of zero degrees) on the left and right cutting profile. Preferably, the blades have an involute profile (FIGS. 4 and 5a) which is derived from the normal tooth profile of a cylindrical gear to be manufactured.

The blades 16 may be face ground which reduces the thickness of the blades until the end of the hob life. Thus, the cutting edges of the blades 16 generally face one of the opposed ends, which, for FIGS. 5(a) and 5(b), is end 21. Thus, the direction of cutting is generally in the axial direction T or at some defined angle with respect to axis T. As the hob is front face sharpened in the direction of blade thickness, the hob outer diameter is reduced which has to be considered in the machine settings after each sharpening. The outer diameter is reduced due to the fact that top relief and side relief in such types of blades are created by a radial profile relief motion of the manufacturing machine while grinding each blade from the top. The actual hob diameter is measured from the toplands (i.e. top surface) of two opposite blades (e.g. 20, 22).

While the tool rotates, the active cutting front changes from one blade to the next, which is dependent on the hand of rotation in an advanced or retracted position. However, rotation alone will not give the individual blades a chip removing motion but only position the following blade in an advanced or retracted location e.g. in a gear slot to be machined

If the axial hob is used in a power skiving process, then the axis of the tool and the axis of the work have to be inclined to one another. As with conventional power skiving, the chip removing surface speed has to be created by this axis inclination (see shaft angle Σ in FIG. 3). The major cutting forces in skiving are directed in axial work gear direction.

FIG. 5(a) shows an axial front end view and FIG. 5(b) shows side (lengthwise) view of a helical axial hob 14. The direction of the first helix (blade orientation) and second helix (front face locations of blades) are indicated in FIG. 5(b). Sharpening of such a hob can be performed with a thin grinding wheel which is inclined to the second helix angle. During the sharpening, the hob can rotate while the grinding wheel follows the helix with a motion in the direction of the hob axis T:

Grinding wheel motion=(Angular cutter velocity)*(Pitch radius of cutter)

As previously mentioned, the blades 16 can be face ground which reduces the thickness of the blades until the end of the hob life. In the direction of the blade thickness, the magnitude of the outer diameter (measured between the toplands of two opposite blades) diminishes due to radial profile relief which causes top relief and side relief). Therefore, as the hob is front face sharpened, its diameter is reduced and this has to be considered in the machine settings after each sharpening.

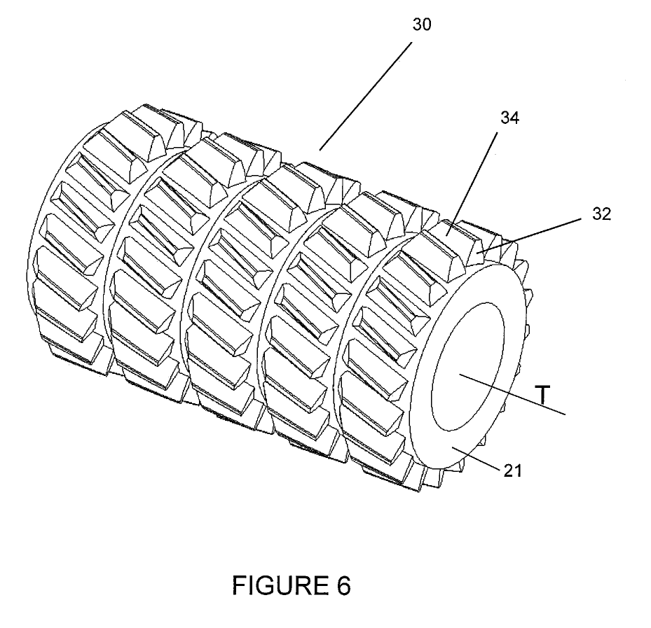

The hob may be manufactured with a ring blade orientation (FIG. 6), which means the blades are not oriented along a helix but in true circles (second helix angle is zero). The individual blades are oriented in a first helix direction similar to the helical hob. In order to arrange the entire hob cylinder with cutting blades, a certain number of layers of cutting blade rings are oriented on the hob base cylinder.

FIG. 6 shows the three dimensional view of an axial zero lead angle hob 30. The previous descriptions of FIGS. 4 and 5 apply except that with this embodiment, the second helix angle is zero resulting in hob lead direction H₂ being perpendicular to hob axis T. If hob 30 is manufactured from a single piece of material (e.g. high speed steel or carbide) and has to be re-sharpened with front face surfaces 32 perpendicular to the first helix direction, then each blade (tooth) 34 has to be sharpened in a single setup with a small diameter grinding wheel so as to avoid interference with surrounding blades.

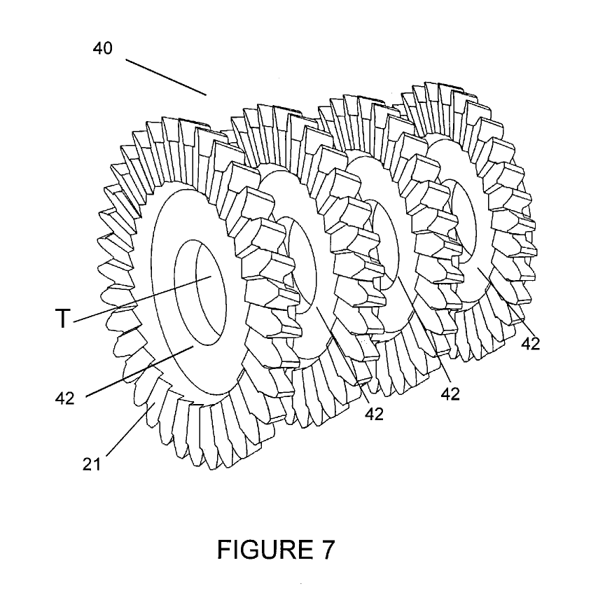

FIG. 7 shows the three dimensional representation of an axial hob comprising a plurality of cutting disks 42. While four disks are shown, the invention contemplates any number of two or more disks. The mounted disk hob has the same features as the zero lead angle hob 30 (FIG. 6). It can be disassembled for re-sharpening and in the case of broken or chipped teeth, a single disk can be replaced. Manufacturing of a mounted multi disk hob is less complicated than the manufacture of a zero lead angle hob because of the smaller individual parts of carbide or high speed steel. The angular orientation of the mounted disks has to be such that the blades follow the first helix correctly from one disk to the next.

The axial hob of FIG. 7 represents a very cost effective way of creating an axial hob. Such a hob is very flexible because it can be mounted to a desired specification, considering the width of a work piece as well as any over travel conditions. Manufacturing of the single disks is more cost effective than manufacturing an entire hob from one solid piece of HSS or carbide. In case of non-uniform wear, cutting edge chipping or even breakage of teeth, it is possible to rearrange the disks (along the cutting direction) or to replace single disks. The multitude of disk cutters has to be mounted such that the rotational orientation of the blades is changed by:

(inclination between tool and work)*(disk spacing distance)/(hob pitch diameter)*180°/π

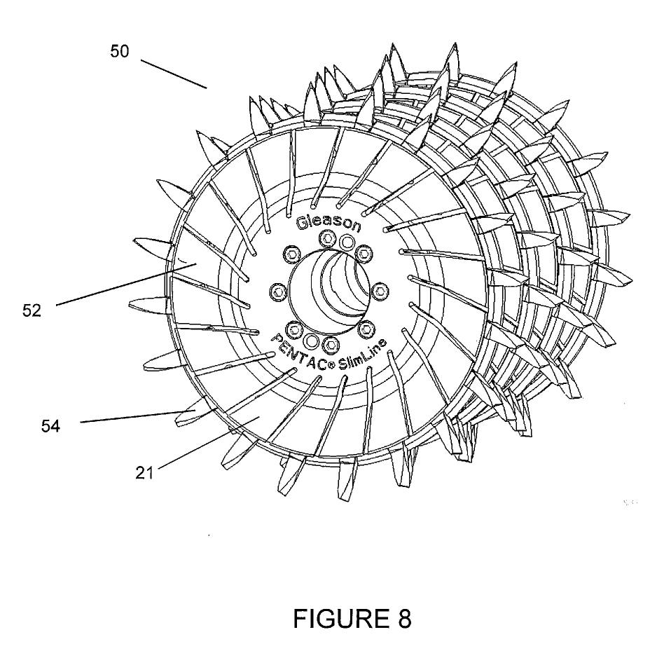

FIG. 8 shows the three dimensional representation of an axial hob 50 comprising a plurality of single disk cutters 52 (four shown) which are each equipped with stick blades 54. The stick blades can be removed and re-sharpened individually. A broken blade can be exchanged with lower cost compared to single disk or solid hobs. The angular orientation of the mounted disks has to be such that the blades follow the first helix (i.e. blade orientation) correctly from one disk to the next.

Axial hob 50 also represents a cost effective and modular way of creating an axial hob by mounting of one or more peripheral cutters behind each other and create a zero lead angle hob. Axial hob 50 is very flexible because it can be mounted to a desired specification, considering the width of a work piece as well as any over travel conditions. In case of non-uniform wear, cutting edge chipping or even breakage of teeth, it is possible to exchange single blades. The multiple cutters 52 have to be mounted such that the rotational orientation of the blades is changed by:

(inclination between tool and work)* (disk spacing distance)/(hob pitch diameter)*180°/π

In order to generate a chip removing motion, the inventive axial hob can be used like a shaper cutter in a shaping process. The advantage is that during the axial stroke, an infeed motion in slot depth direction can be introduced which would allow cutting of the entire slot depth in one single stroke. A roll motion between cutter and work is still required in order to generate the involute profile. After one work piece revolution, the work is either finished or roughed out. In case of high gear quality and high surface finish requirement, a second work revolution with a finishing stroke can be applied. Additional work revolutions each with a respective finishing stroke are also contemplated. For finishing, the cutter may be repositioned in the axial direction to utilize a fresh section of the tool which is used only for finishing.

In order to generate a chip removing motion, the axial hob can be used like a broach. While the hob performs a broaching stroke (similar to shaping), the hob is set to whole depth and rotates (with the correct ratio with the work) such that in one single stroke, an internal cylindrical gear is finished. For high surface finish and lower cutting forces, a gear can be finished in several strokes. In the case of a semi-broaching process, the teeth should be staggered from one end of the hob to the other end of the hob. Thus, the diameter of the hob increases from the side of the hob where cutting begins (front end) to the side of the hob where the cutting ends (back end).

If the axial hob is used in a power skiving process, the axis of the tool and the axis of work have to be inclined. As with conventional power skiving, the chip removing surface speed has to be created by this axis inclination (see FIG. 3).

The inventive axial hob is suitable for the production of gears on machines including, but not limited to, gear shaping machines, power skiving machines, multi-axis free-form bevel and hypoid gear machines (e.g. U.S. Pat. No. 6,712,566) and five-axis machining centers.

### EXAMPLE 1

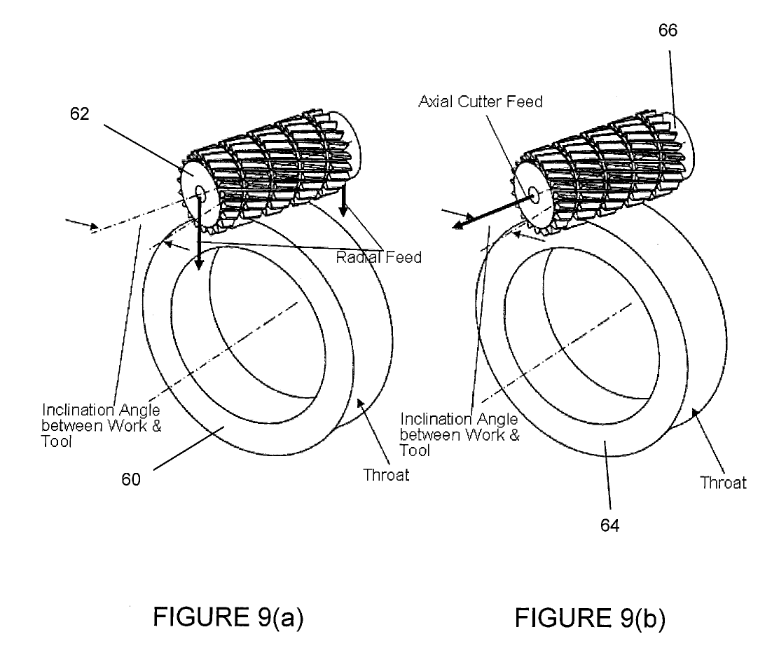

An axial hob is positioned with the crossing point of the hob and work axis in the middle of the face width of the work (on the outside of the work) and the tool is fed into the work material by feeding in the radial work direction (towards the inside). A generated “cylindrical” gear having a throat is formed. The enveloping cylinder of the hob blade tips has the shortest distance to the centerline of the work gear in the middle of the face width (see FIG. 9(a)). This distance increases in both directions towards the ends of the cylindrical work gear and therefore form an enveloping or throated gear.

FIG. 9(a) shows the orientation between tool and work for the power skiving of an external gear 60 with an axial hob 62. The feed direction is a radial infeed. The geometry of the generated external cylindrical gear shows a throat in the pitch element. The pitch element is not cylindrical but a hyperboloid.

### EXAMPLE 2

An axial hob is positioned with the crossing point of the hob and work axis in the middle of the face width of the work and the hob is shifted along its axis to the outside of the work gear in order to clear the work. In this example, the shifting is an axial feed motion applied in the direction of the cutting tool axis (see FIG. 9(b)). Also in this example, the generated “cylindrical” gear would have a throat. The enveloping cylinder of the hob blade tips has the shortest distance to the centerline of the work gear in the middle of the face width. This distance increases as in both directions towards the ends of the cylindrical work gear which forms the throat.

FIG. 9(b) shows the orientation between tool and work for the power skiving of an external gear 64 with an axial hob 66. The feed is in axial hob direction. With the axial feed direction, the resulting geometry of the generated external cylindrical gear is a throat in the pitch element. The pitch element is not cylindrical but a hyperboloid.

### EXAMPLE 3

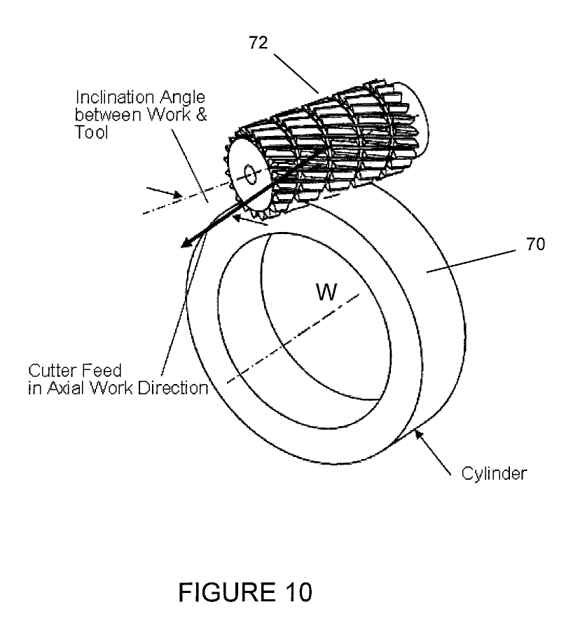

FIG. 10 shows the orientation between tool and work for the power skiving of an external gear 70 with an axial hob 72. The feed direction of the hob is in the direction of the axis W of the work gear 70. With this feed direction, a complete roll out of the pitch element is achieved. The resulting pitch element is cylindrical.

The hob 72 is positioned such that the axes crossing point is at a known distance from the face on one side of the work gear 70 (on the outside of the work) and an axial feed motion is applied in the direction of the work axis. As a result, the shortest distance between the enveloping cylinder of the hob blade tips and the work gear axis will sweep along the face width while the feed motion moves the hob in direction of the work gear axis. The ratio, i, between the work rotation and the hob rotation is calculated from:

i=Z_{hob}/Z_{work}

where:
Z_{hob}=number of blade “starts” on the hob
Z_{work}=number of teeth on the workpiece

RPM_{hob}=RPM_{work}*i

In order to generate a correct involute profile and a correct lead angle, the work (or the hob) have to perform a superimposed differential rotation Δφ. The differential rotation Δφ for the hob is calculated:

Δφ=2*(axial feed amount)*sin(helix angle of workpiece)/(pitch diameter)

The differential rotation Δφ becomes zero in case the work gear is a spur gear. The generated pitch element is cylindrical in this case.

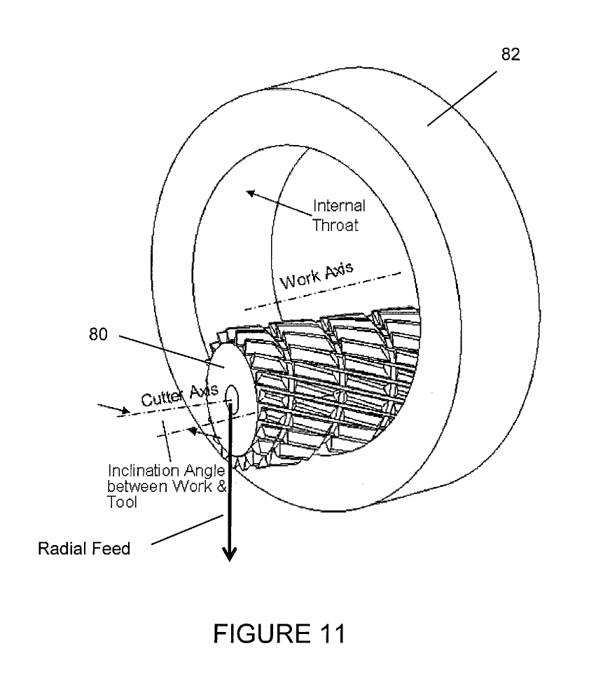

FIGS. 11-13 (Examples 4-6) show the orientation between an axial hob and a work piece for the power skiving of an internal gear with an axial hob. The feed direction of the hob is either radial, in axial hob direction or in axial work gear direction. The radial plunge and the feed axially to the hob axis generate a hyperbolic pitch element (throat pitch element). Such an internal gear might be used for a crossed axis arrangement, where the internal gear meshes with a cylindrical pinion.

### EXAMPLE 4

With reference to FIG. 11, an axial hob 80 is positioned with the crossing point of the hob (cutter) axis and work piece axis in the middle of the face width of the work piece 82 (on the inside of the work) and the hob 80 is fed in the radial work direction into the work (towards the outside). A throated internal gear is created.

### EXAMPLE 5

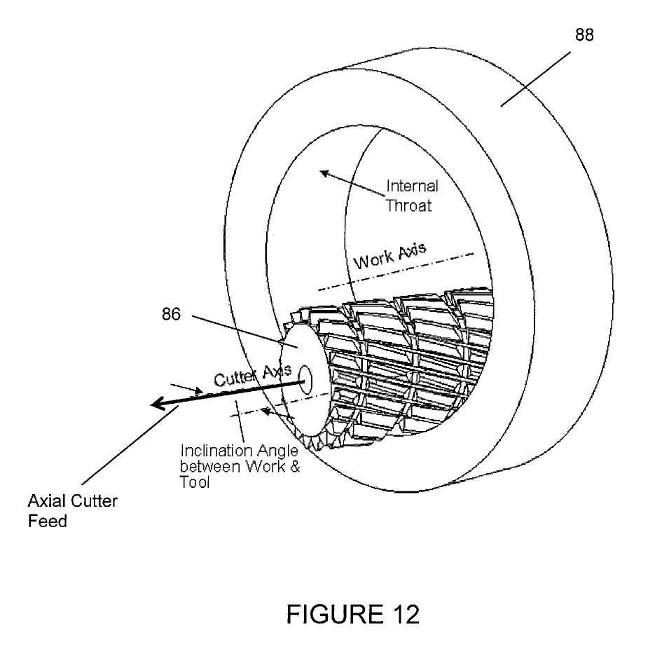

With reference to FIG. 12, an axial hob 86 is positioned such that the crossing point of the hob (cutter) axis and workpiece axis is at a known distance from the face on one side of the work gear 88 (on the inside of the work) and an axial feed motion is applied in the direction of the hob axis. A throated internal gear is created.

### EXAMPLE 6

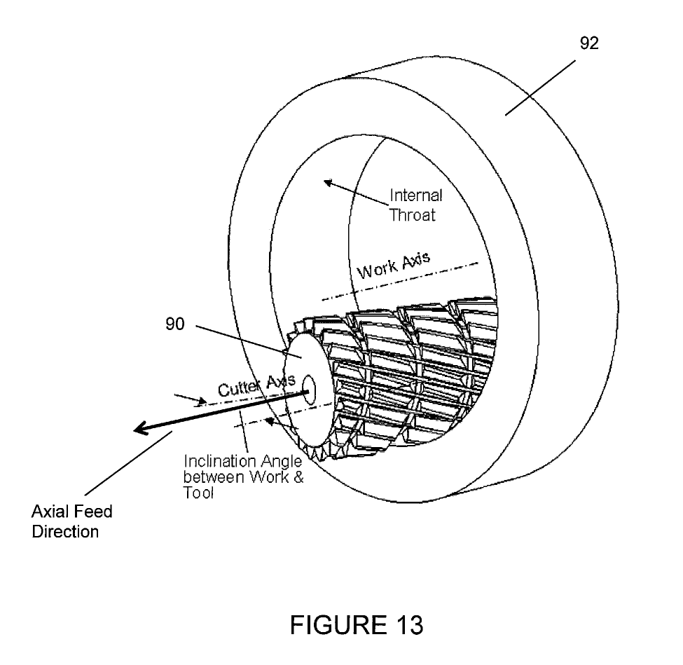

With reference to FIG. 13, an axial hob 90 is positioned such that the crossing point of the hob and workpiece axes is at a known distance from the face on one side of the work gear 92 (on the inside of the work) and an axial feed motion is applied in the direction of the work axis. In this case, the work gear will be mutilated by the two ends of the hob and the work gear will be destroyed.

Applying a feed which in the direction of the work gear axis will mutilate the internal gear to the extent that the teeth are removed (resulting in a root cylinder blank). The mutilation becomes larger as the length of the hob becomes greater.

While the invention has been described with reference to preferred embodiments it is to be understood that the invention is not limited to the particulars thereof. The present invention is intended to include modifications which would be apparent to those skilled in the art to which the subject matter pertains without deviating from the spirit and scope of the appended claims.

What is claimed is:

1. An axial hob for machining gears and other toothed articles, said axial hob being cylindrically shaped and comprising:
a length, a diameter and a pair of axially opposed ends, an axis of rotation extending the length of said hob with said axial hob being rotatable about said axis, a plurality of cutting teeth arranged about said hob, said teeth being oriented in a first direction defined by a first helix angle with respect to said axis of rotation, wherein each of said cutting teeth includes a cutting face and wherein all cutting faces are oriented toward one of said axially opposed ends.

2. The axial hob of claim 1 further comprising said cutting teeth being oriented in a second direction defined by a second helix angle with respect to a line perpendicular to said axis of rotation.

3. The axial hob of claim 1 wherein said first direction and said second are perpendicular to one another.

4. The axial hob of claim 2 wherein said second helix angle equals zero degrees.

5. The axial hob of claim 1 wherein said hob comprises a plurality of cutting disks each of which having cutting teeth arranged about the periphery thereof, said cutting disks being serially arranged in the axial direction and being rotationally oriented with respect to one another whereby the cutting teeth of all disks are collectively arranged to be oriented in a first direction with respect to said axis of rotation so as to define said first helix angle.

6. The axial hob of claim 1 wherein each cutting face comprises a left cutting profile and a right cutting profile.

7. The axial hob of claim 6 wherein said left cutting profile and said right cutting profile are each of a shape in the form of an involute.

8. The axial hob of claim 6 further comprising equal side rake angles on the left and right cutting profiles.

9. The axial hob of claim 1 wherein each cutting face is formed on a replaceable cutting blade.

10. A method of manufacturing a gear from a gear workpiece with an axial hob, said gear workpiece having an axis of rotation, said method comprising:
providing an axial hob, said axial hob being cylindrically shaped and comprising a length, a diameter and a pair of axially opposed ends, an axis of rotation extending the length of said hob with said axial hob being rotatable about said axis, a plurality of cutting teeth arranged about said hob, said teeth being oriented in a first direction defined by a first helix angle with respect to said axis of rotation, wherein each of said cutting teeth includes a cutting face and wherein all cutting faces are oriented toward one of said axially opposed ends,
rotating said hob and said gear workpiece about their respective axes of rotation at a predetermined ratio,
orienting said axial hob axis of rotation at an inclination angle with respect to the gear workpiece axis,
moving said hob across an outer surface of said gear workpiece in a feed direction parallel to the axis of rotation of said gear workpiece.
